(19) United States
(12) Patent Application Publication
(10) Pub. No.: US 2014/0014506 A1
(43) Pub. Date: Jan. 16, 2014

(54) ANALYTE TRANSPORT

(71) Applicant: Krassen Dimitrov, Indooroopilly (AU)

(72) Inventor: Krassen Dimitrov, Indooroopilly (AU)

(73) Assignee: THE UNIVERSITY OF QUEENSLAND, ST. LUCIA (AU)

(21) Appl. No.: 13/993,248

(22) PCT Filed: Dec. 14, 2011
(86) PCT No.: PCT/AU11/01618

§ 371 Date: Sep. 30, 2013

(30) Foreign Application Priority Data
Dec. 14, 2010 (AU) 20100905482

(51) Int. Cl. G01N 27/30

(52) U.S. Cl. CPC G01N 27/30
USPC 204/400

(57) ABSTRACT

Apparatus for sensing an analyte, the analyte being bound to at least one magnetic particle to form a labelled analyte, and wherein the apparatus includes a cavity having a sensor therein, wherein in use the cavity contains a fluid and at least one labelled analyte and a magnet system for generating a magnetic field having a field direction substantially orthogonal to at least part of the cavity to orientate the at least one labelled analyte in the cavity and a field gradient along at least part of the cavity to thereby urge the at least one labelled analyte along the cavity towards the sensor.

### BACKGROUND OF THE INVENTION

This invention relates to an apparatus for sensing an analyte, and an apparatus for transporting an analyte to a sensor to allow sensing of the analyte.

1. Description of the Prior Art

Reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Analyte detection and quantification is important in many different technical areas such as biomedical research (both in industry and in academia), clinical diagnostics, agricultural diagnostics and practices, environmental control, forensics, personalized medicine, pharmacogenomics, and others. For example, it is often desirable to be able to detect the presence and/or levels of analytes in biological samples taken from a subject to allow clinical diagnosis to be performed.

In order to assist with analyte detection, it is known to bind analytes to labels, allowing the analytes to be more easily sensed. This is described for example in US2009/220978, which describes a diverse population of uniquely labeled probes, containing about thirty or more target specific nucleic acid probes each attached to a unique label bound to a nucleic acid. Also provided is a method of producing a population of uniquely labeled nucleic acid probes. The method consists of (a) synthesizing a population of target specific nucleic acid probes each having a different specifier; (b) synthesizing a corresponding population of anti-genedigits each having a unique label, the population having a diversity sufficient to uniquely hybridize to genedigits within the specifiers, and (c) hybridizing the populations of target nucleic acid probes to the anti-genedigits, to produce a population in which each of the target specific probes is uniquely labeled. Also provided is a method of detecting a nucleic acid analyte. The method consists of (a) contacting a mixture of nucleic acid analytes under conditions sufficient for hybridization with a plurality of target specific nucleic acid probes each having a different specifier; (b) contacting the mixture under conditions sufficient for hybridization with a corresponding plurality of anti-genedigits each having a unique label, the plurality of anti-genedigits having a diversity sufficient to uniquely hybridize to genedigits within the specifiers, and (c) uniquely detecting a hybridized complex between one or more analytes in the mixture, a target specific probe, and an anti-genedigit.

The use of magnetic particles in analyte detection is also known, with these being used to allow the analyte to be transported for example, using a magnetic field. An example of such an arrangement is described in US2007/292877 describes labels for electronic detection of individual molecules. The labels are comprised of elements with different electrical properties that affect the electric current flowing through a nanoelectrode. The labels are of polymeric or filamentous structure where the elements are arranged linearly along their length. The arrangement of the elements is predetermined and combinatorial, so that a high diversity of labels can be generated in a manner that resembles barcoding on a nanoscale level. Methods for the synthesis of said barcode labels and for the binding of the barcode labels to individual molecules, their movement past a nanoelectrode, and their detection are also provided. However, the fast, reliable and accurate detection of analytes using the above labels, necessitates further improvements and innovations in magnetophoretic arrangements.

In an alternative arrangement “Magnetophoresis of flexible DNA-based dumbbell structures” by B. Babić, R. Ghai, and K. Dimitrov, Applied Physics Letters 92, 053901 (2008), describes controlled movement and manipulation of magnetic micro- and nanostructures using magnetic forces can give rise to important applications in biomedecine, diagnostics, and immunology. The paper describes controlled magnetophoresis and stretching, in aqueous solution, of a DNA-based dumbbell structure containing magnetic and diamagnetic microspheres. However, this document only describes the use of external optical sensing, which requires manual monitoring, making the process unsuitable for automated detection, as well as limiting the range of analyte detection that can be performed.

### SUMMARY OF THE PRESENT INVENTION

In a first broad form the present invention seeks to provide apparatus for sensing an analyte, the analyte being bound to at least one magnetic particle to form a labelled analyte, and wherein the apparatus includes:
a) a cavity having a sensor therein, wherein in use the cavity contains a fluid and at least one labelled analyte; and,
b) a magnet system for generating a magnetic field having a field direction substantially orthogonal to at least part of the cavity to orientate the at least one labelled analyte in the cavity and a field gradient along at least part of the cavity to thereby urge the at least one labelled analyte along the cavity towards the sensor.

Typically the sensor is provided on a wall of the cavity, and wherein the field gradient urges the at least one labelled analyte towards the sensor.

Typically the field gradient extends in a field gradient direction, the field gradient direction being at an angle relative to the cavity at least near the sensor to thereby urge the at least one labelled analyte towards the sensor.

Typically the field gradient includes a component along the cavity and a component orthogonal to the cavity to thereby urge the labelled analyte along the cavity and towards the sensor.

Typically the magnet system includes:
a) a first magnet positioned adjacent at least part of the cavity for generating a magnetic field having a field direction substantially orthogonal to the cavity and a field gradient along the cavity; and,
b) at least one body for modifying the magnetic field near the sensor to thereby at least one of:
   i) increase the field gradient; and,
   ii) modify a field gradient direction.

Typically the at least one body includes at least one of:
a) a second magnet; and,
b) a third magnetic body.

Typically the sensor is positioned substantially between the first and second magnets.

Typically the sensor is positioned substantially between the second magnet and the third body.

Typically the third body is positioned between the first magnet and the cavity, and the cavity is positioned between the second magnet and the third body.

Typically the first magnet defines a substantially circular plane, at least part of the cavity extending in a direction substantially parallel to the plane and radially outwardly towards a circumference of the first magnet.

Typically the cavity includes:
a) a first cavity portion extending towards a centre of the circular plane at an angle relative to the plane; and,
b) a second cavity portion extending from the first cavity portion in a direction substantially parallel to the plane and radially outwardly towards the circumference of the region.

Typically the at least one body is positioned adjacent the cavity radially outwardly from a centre of the first magnet.

Typically the first magnet is at least one of a rare earth magnet and an electromagnet.

Typically the first magnet is a disc magnet.

Typically the second magnet is at least one of a rare earth magnet and an electromagnet.

Typically the second magnet is at least one of a cylindrical and a spherical magnet.

Typically the third body is a ferromagnetic material.

Typically the third body is hemispherical body coupled to the first magnet.

Typically the apparatus includes:
a) a first housing containing the cavity; and,
b) a second housing containing the magnet system, and wherein the second housing includes a recess for receiving the first housing to thereby position the cavity relative to the magnet system.

Typically the first housing includes:
a) a first housing portion containing a first cavity portion; and,
b) a second housing portion containing a second cavity portion.

Typically the sensor includes electrodes for determining a diffusion-limited electrochemical current.

In a second broad form the present invention seeks to provide apparatus for transporting an to analyte to a sensor to allow sensing of the analyte, the analyte being bound to at least one magnetic particle to form a labelled analyte, and wherein the sensor is mounted in a cavity containing a fluid and at least one labelled analyte, and wherein the apparatus includes a magnet system for generating a magnetic field having a field direction substantially orthogonal to at least part of the cavity to orientate the at least one labelled analyte in the cavity and a field gradient along at least part of the cavity to thereby urge the at least one labelled analyte along the cavity towards the sensor.

Typically a first housing contains the cavity and wherein the apparatus includes a second housing containing the magnet system, the second housing including a recess for receiving the first housing to thereby position the cavity relative to the magnet system.

### BRIEF DESCRIPTION OF THE DRAWINGS

An example of the present invention will now be described with reference to the accompanying drawings, in which:

FIG. 1A is a schematic diagram of an example of apparatus for transporting and sensing an analyte;

FIG. 1B is a schematic diagram of an example of a labelled analyte;

FIG. 1C is an example image showing labelled analytes within the cavity of FIG. 1A;

FIG. 1A is a schematic diagram of an example of apparatus for sensing an analyte;

FIGS. 2A and 2B are schematic side and plan views of a second example of apparatus for transporting and sensing an analyte;

FIG. 3A is a schematic diagram of an example of the magnetic field B in a horizontal plane for the apparatus of FIG. 2A;

FIG. 3B is a schematic diagram of an example of the magnetic field B in a vertical plane for the apparatus of FIG. 2A;

FIG. 3C is a schematic diagram showing a portion of the magnetic field of FIG. 3B in more detail;

FIG. 3D is a graph showing an example of the magnetic field B and magnetic field gradient along the cavity of FIG. 2A;

FIG. 3E is a schematic diagram of an example of the magnetic force Fₘ in the horizontal plane for the apparatus of FIG. 2A;

FIG. 3F is a schematic diagram of an example of the magnetic force Fₘ in the vertical plane for the apparatus of FIG. 2A;

FIG. 3G is a graph showing an example of the magnetic force Fₘ and its x,y z components along the cavity of FIG. 2A;

FIG. 4 is a schematic diagram of a third example of apparatus for transporting and sensing an analyte;

FIGS. 5A and 5B are schematic side and plan views of a fourth example of apparatus for transporting and sensing an analyte;

FIG. 6A is a schematic diagram of an example of the magnetic field B in a vertical plane for the apparatus of FIG. 5A;

FIG. 6B is a graph showing an example of the magnetic force Fₘ and its x,y z components along the cavity of FIG. 5A;

FIG. 7A is a schematic diagram of an example of the magnetic field B in a vertical plane for a fifth example of apparatus for transporting and sensing an analyte;

FIG. 7B is a graph showing an example of the magnetic force Fₘ and its x,y z components along the cavity of the fifth example of apparatus for transporting and sensing an analyte;

FIG. 8A is schematic side view of an example of a magnet system for use in apparatus for transporting and sensing an analyte;

FIGS. 8B to 8D are schematic diagrams showing an example of the modelled magnetic field distribution for the magnet system of FIG. 8A;

FIGS. 8E and 8F are schematic diagrams of an example of the modelled magnetic force profile for the magnet system of FIG. 8A, along the y and z axes, respectively;

FIGS. 8G and 8H are images of a physical embodiment of the magnet system of FIG. 8A;

FIG. 9A is a schematic side view of a sixth example of apparatus for transporting and sensing an analyte;

FIG. 9B is a schematic side view of the first housing of FIG. 9A in further detail; and,

FIG. 9C is a schematic diagram of the magnetic force Fₘ along the cavity of FIG. 9A.

### DETAILED DESCRIPTION OF THE PREFERRED EMBODIMENTS

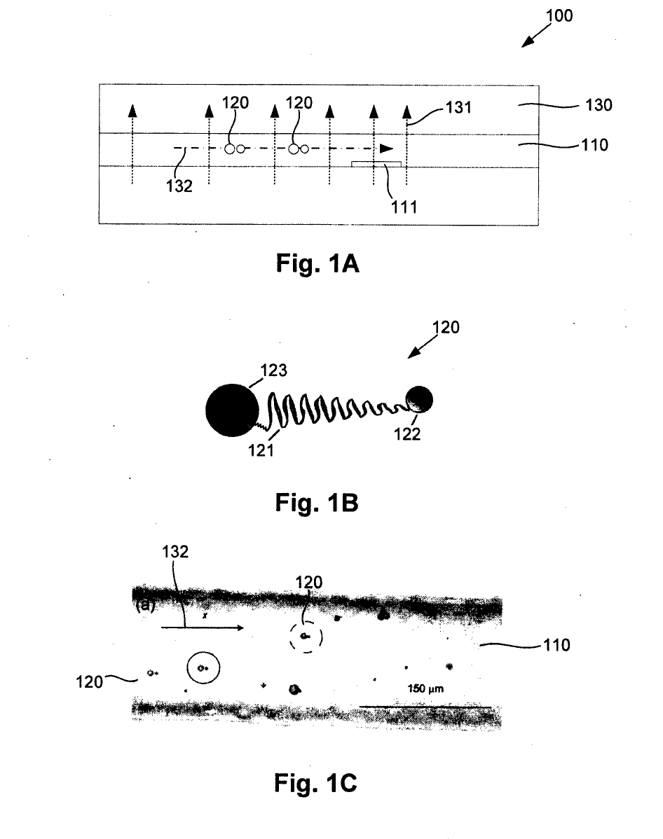

An example of apparatus for transporting and sensing an analyte will now be described with reference to FIGS. 1A to 1C.

In this example, the apparatus 100 includes a cavity 110 having a sensor 111 mounted or embedded therein. In use, the cavity, which may be in the form of a channel, chamber or the like, contains a fluid, such as an electrolyte, and at least one labelled analyte 120. The labelled analyte 120, an example of which is shown in more detail in FIG. 1B, typically includes an analyte 121 bound to a magnetic particle 122, and more typically includes an analyte 121, bound to a magnetic particle 122 and a non-magnetic particle 123.

The nature of the analyte 121, as well as the magnetic and non-magnetic particles 122, 123 will vary depending on the preferred implementation. In one example, the analyte is an antigen, which is bound to a non-magnetic bead and a cobalt bead with or without a DNA-based linker and bridging antigen. However, commercially available micrometer-sized magnetic beads in the form of polymer spheres containing homogenously dispersed super-paramagnetic iron oxide nanoparticles could alternatively be used. In this example, to make the beads suitable for biological uses, their surface is typically functionalized with high affinity binding proteins, such as, streptavidin or protein A. Such affinity functionalized beads can then be bound to the analyte using an appropriate binding agent. Further alternative arrangements can also be used, as described for example in US2007/292877 and US2009/220978. Alternatively, the magnetic particle may be made from permalloy, as described in [Qin, G., F. Darain, H. Wang, K. Dimitrov. “Surface modification of permalloy nanoparticles for biomedical applications.” J. Nanopart. Res. 13(1): 2011 45-51.] or other ferromagnetic materials.

The apparatus 100 also includes a magnet system 130 for generating a magnetic field. The magnetic field generated by the magnet system 130 can be used to transport the labelled analyte, and therefore the analyte, along the cavity 110 towards the sensor 111 in a controlled manner. To achieve this, the magnetic field has a field direction substantially orthogonal to at least part of the cavity 110, as shown by the arrows 131, as well as a field gradient along at least part of the cavity 110.

In use, the direction of the magnetic field acts to orientate labelled analytes 120 in the cavity 110. In particular, the dipole of the magnetic bead 122 aligns with the field direction of the magnetic field direction. The increasing field gradient along the cavity 110 generates an overall force extending in the direction of the arrow 132, thereby urging the labelled analyte along the cavity 110 towards the sensor 111. In one example, the magnitude of the field gradient increases in the vicinity of the sensor 111, thereby causing the labelled analytes 120 to accelerate as they near the sensor 111. Acceleration of the labelled analytes near the sensor 111 can have a number of benefits, such as increasing the separation between adjacent labelled analytes 120, and stretching the labelled analytes 120, which in turn lead to more accurate sensing of the analytes.

The sensor 111 may be any form of sensor, but in one example includes a nano-electrode sensor similar to that described in US2007/292877. In this example, the sensor 111 is used to measure the diffusion-limited electrochemical current of the fluid in the cavity 110, with the diffusion-limited electrochemical current being sensitive to the presence of an analyte.

Typically, the sensitivity of the sensor 111 will vary depending on the physical separation of the sensor 111 and the labelled analyte 120. Accordingly, it is preferable for the magnetic field to be configured relative to the cavity 110 to minimise physical separation of the labelled analyte 120 from the sensor 111. The manner in which this is achieved will depend on the preferred implementation. However, the sensor 111 is generally provided on a wall of the cavity 110, in which case the field gradient is configured to urge the at least one labelled analyte towards the sensor 111, typically by having the field gradient extend in a field gradient direction that is at an angle relative to the cavity 110 at least near the sensor 111, thereby urging the at least one labelled analyte 120 towards the sensor.

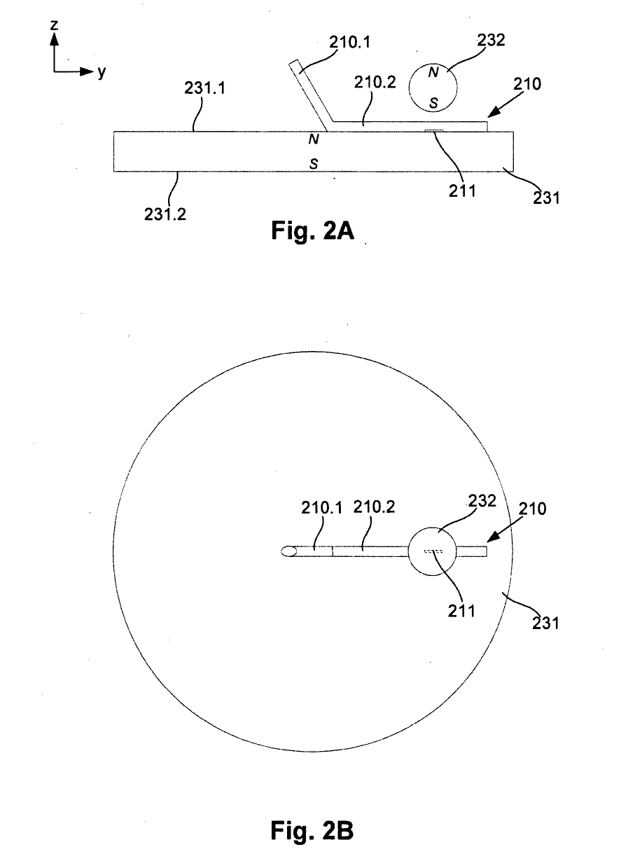

An example analyte transport and sensing system will now be described in more detail with reference to FIGS. 2A and 2B.

In this example, the magnet system 230 includes a first magnet 231 positioned adjacent at least part of a cavity 210 for generating a magnetic field having a field direction substantially orthogonal to the cavity 210 and a field gradient along the cavity 210. A second magnet 232 is provided near the sensor 211 for modifying the magnetic field to thereby increase the field gradient and/or modify the field gradient direction.

In the current example, the first magnet 231 is a substantially disc shaped magnet having a surface 231.1 that defines a substantially circular plane. In this example, the cavity 210 includes a first cavity portion 210.1 extending towards a centre of the circular plane at an angle relative to the plane and a second cavity portion 210.2 extending from the first cavity portion in a direction substantially parallel to the plane and radially outwardly towards the circumference of the circular plane. Accordingly, in this arrangement at least part of the cavity 210 extends in a direction substantially parallel to the plane and radially outwardly towards a circumference of the plane defined by the surface 231.1 of the first magnet 231.

In addition to this, the magnet system 230 includes a second substantially spherical magnet 232, positioned so that the cavity passes between the first and second magnets, with the sensor 211 being positioned substantially between the first and second magnets 231, 232.

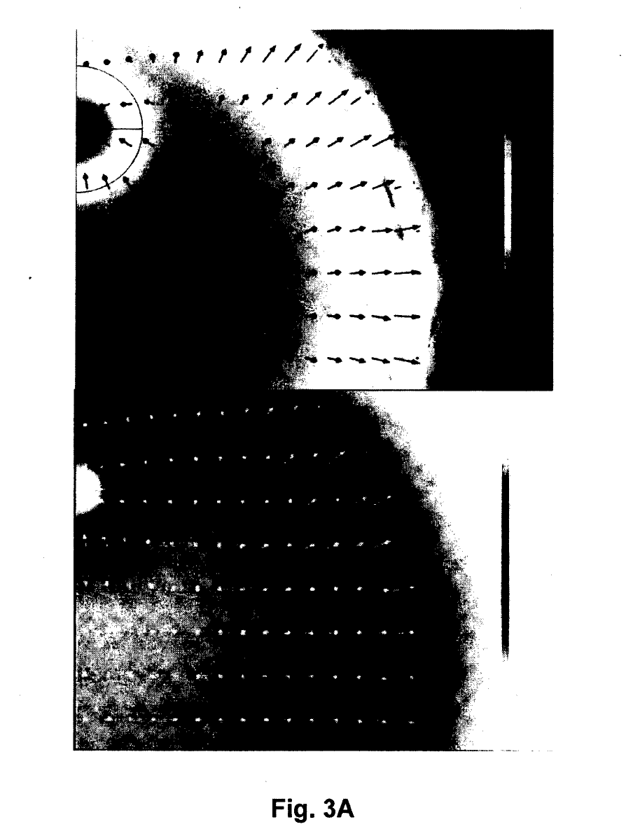

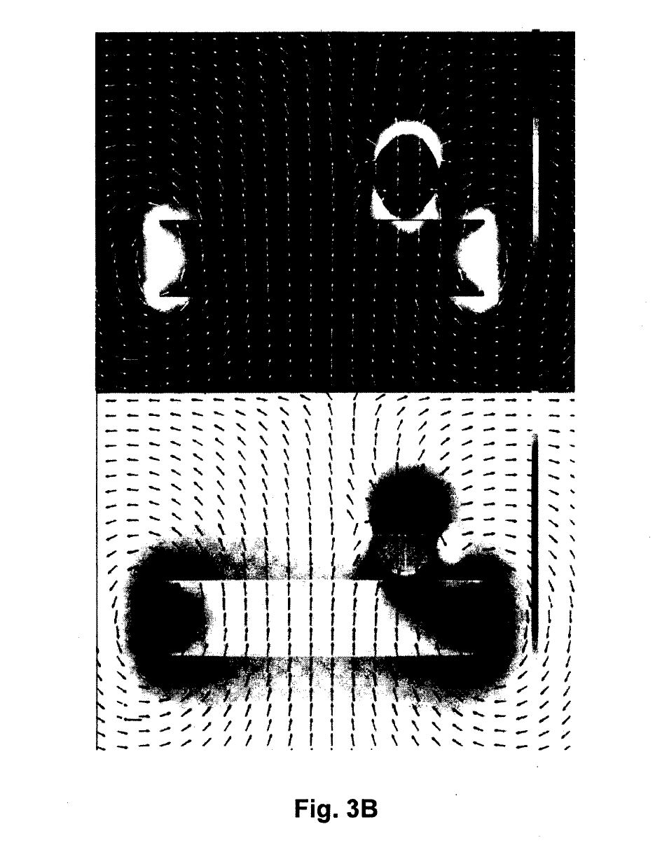

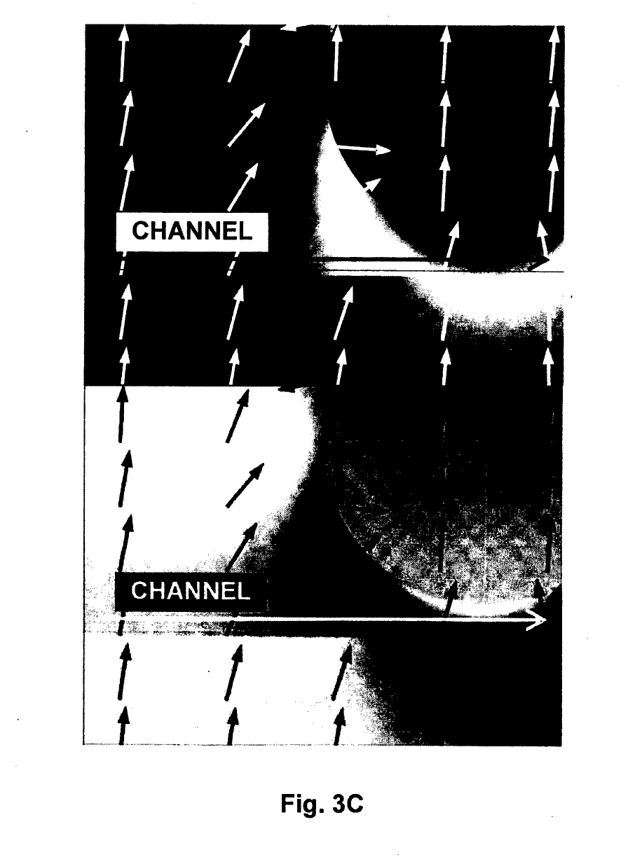

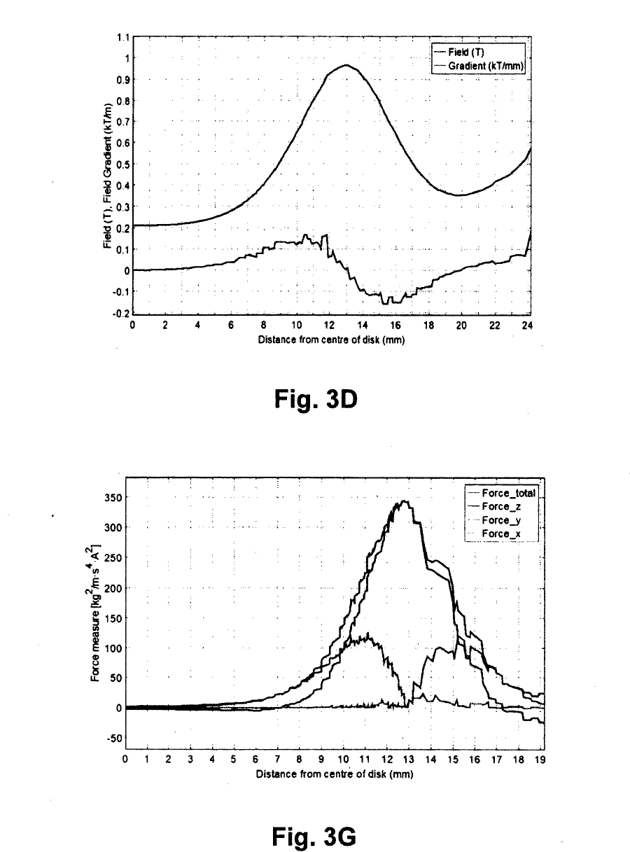

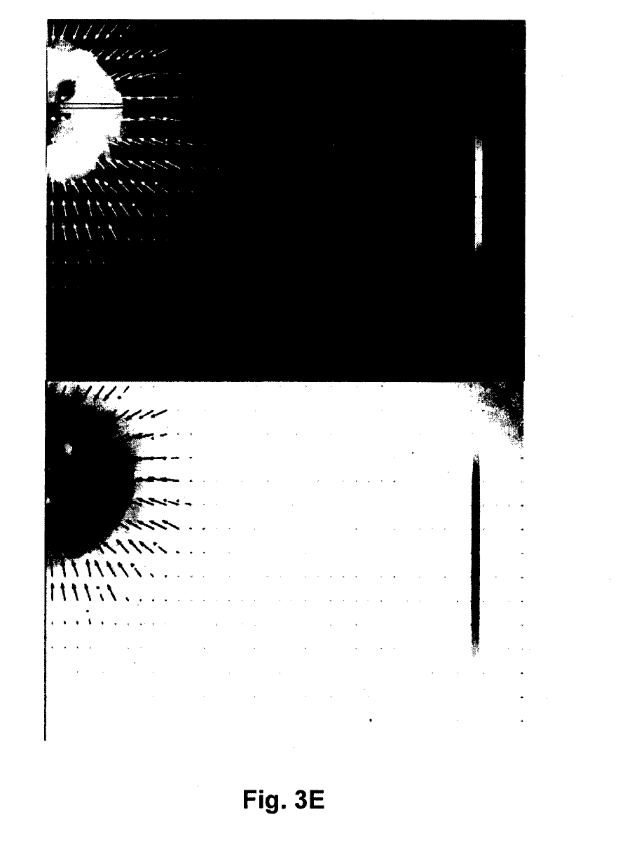

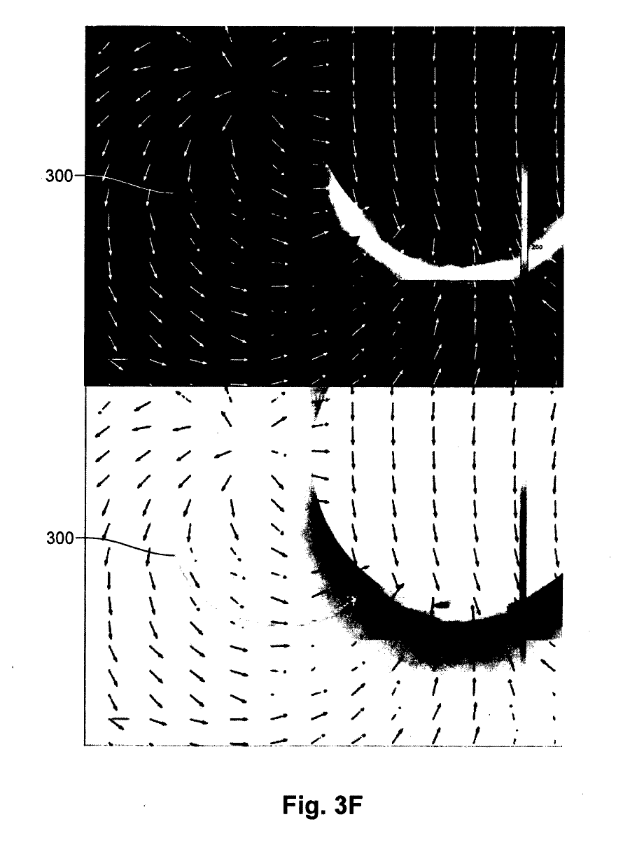

An example of the magnetic field generated by the magnet system of FIGS. 2A and 2B will now be described in more detail with reference to FIGS. 3A to 3G.

For the purpose of this example, the magnetic field is modelled using COMSOL Multiphysics simulation software to computationally model the setup of magnets 231, 232. This software package uses the finite element method to solve for a variety of variables including magnetic field strength, to predict the magnetic field and force acting on a magnetic labelled analyte.

For this example, the second magnet 232 is assumed to be a spherical permanent magnet having a diameter of 10 mm, whilst the first magnet 231 is a permanent disc magnet 10 mm thick and with a diameter of 50 mm. The second magnet 232 is positioned 1 mm above the surface 231.1 of the first magnet 231, with a centre of the sphere being positioned 12 mm radially inwardly of the circumference of the first magnet 231. Both magnets 231, 232 are assumed to be permanent magnets manufactured from Neodymium (NdFeB) (grade N48) having a remanent flux density Bᵣ of 1.4 T and a relative permeability μᵣ of 1. Both magnets 231, 232 are orientated with north poles facing in the direction of the z-axis, as shown in FIG. 2A, although it will be appreciated that reverse polarity configurations could be used.

In this arrangement, the resulting magnetic field in a x-y plane equidistant between the sphere and disc is shown in FIG. 3A, with the field in a y-z plane through the cavity being shown in FIG. 3B. As shown, the magnetic flux passes through the disc magnet 231, across the 1 mm air gap between the magnets, through the spherical magnet 232, before looping back down to a second surface 231.2 of the disc magnet 231. The model predicts magnetic fields ranging from 0 T in the middle of the disc, to 1 T directly underneath the sphere, which provides a sufficient field gradient along the cavity to accelerate the labelled analytes towards the sensor 211, as required. The strongest field is beneath the spherical magnet 232 because this is the point where the distance between the two magnets is minimised and the fields produced by each magnet 231, 232 interact with each other. Both the field strength B and field gradient ∇B increase as the second cavity portion 210.2 extends from the centre of the disc magnet 231 towards the second magnet 232.

The resulting gradient of the magnetic field along the cavity 210 is shown in more detail in FIGS. 3C and 3D. As mentioned above, the maximum magnetic field is 1 T directly between the magnets 231, 232, which occurs 13 mm from the centre of the first magnet 231. However at this point, the field gradient ∇B is zero, meaning that the labelled analytes will experience no magnetic force at this point, and should therefore stop moving altogether due to frictional forces generated by the fluid in the cavity. The maximum field gradient occurs slightly prior to this at 11 mm outwards from the centre of the first magnet 231, at which point the field has a strength of 0.8 T. This is where the labelled analytes will experience the greatest magnetic force acting on them and will be moving at a maximum velocity. Hence it is here that any sensors 211 for detecting the labelled analytes should be positioned. These resulting magnetic forces Fₘ acting on the labelled analytes are shown for the x-y and y-z planes in FIGS. 3E and 3F, respectively.

FIG. 3F also shows an example trajectory of a magnetic labelled analyte within the cavity. In this example, it is apparent that as the labelled analyte moves towards the second magnet 231, the trajectory is directed in a positive z-direction towards the second magnet 232, as shown by the arrow 300. Sensors 211 are typically placed on a bottom surface of the cavity 210, which is nearest to the first magnet 231. The reason for this is that the sensor 211 is typically embedded in a flat integrated circuit as this type of architecture is amenable to high volume CMOS manufacturing. Consequently, the sensor 211 is more easily embedded in the bottom of the cavity 210, whilst the arrangement also allows the first cavity portion 210.1 to be positioned to approach the second cavity portion 210.2 from a side opposite that to on which the sensor 211 is mounted, both to improve flow of labelled analytes towards the sensor 211, and to avoid overcrowding associated with providing both the first cavity portion 210.1 and sensor on the same side of the cavity. In any event, given this arrangement and the generated field, this typically results in the labelled analytes moving away from the sensors 211, which is undesirable.

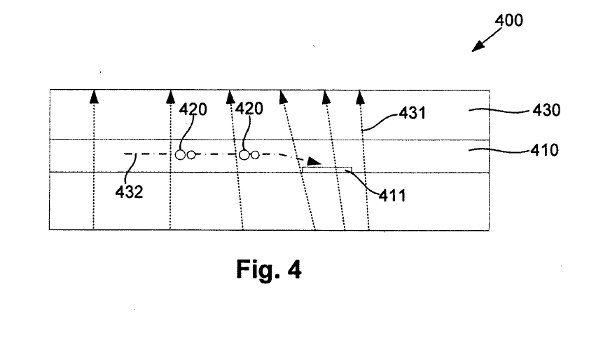

The graph of the forces on labelled analytes 220 in the cavity 210 are shown in more detail in FIG. 3E. This highlights not only that almost all of the y-z plane forces are in a positive z-direction, but also that F_{z}>F_{y} and hence that the labelled analyte experiences a greater force in the z-direction than the y-direction. Accordingly, it is preferable that the field generated by the magnet system is adjusted so that the labelled analytes are urged towards the sensor 211, as will now be described with reference to FIG. 4.

In this example, the apparatus 400 includes a cavity 410 having a sensor 411 mounted therein, the cavity 410 containing a fluid and at least one labelled analyte 420. In this example, the apparatus 400 includes a magnet system 430 for generating a magnetic field, which again has a field direction 431 substantially orthogonal to at least part of the cavity 410, and a field gradient along at least part of the cavity 410. However, in this example, the field is modified in the vicinity of the sensor 411, so that the overall field gradient extends in a direction at an angle relative to the cavity. In other words, the field gradient includes a positive component in the y-direction (along the cavity) and a significant negative component in the z-direction (towards the sensor). This urges the labelled analytes 420 along the cavity 410 towards the sensor as shown by the arrows 432.

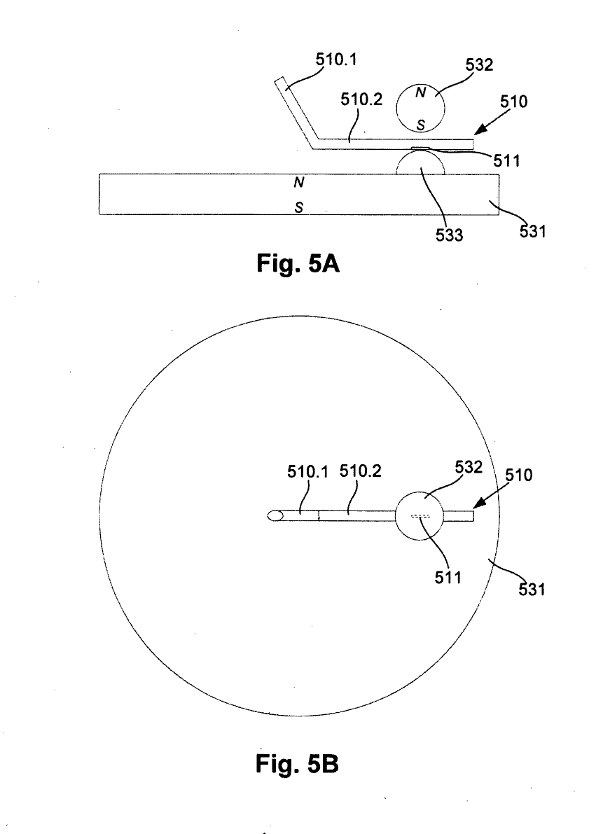

A specific example of a transport and sensing apparatus including a magnet system for urging the labelled analytes towards a sensor will now be described in more detail with reference to FIGS. 5A and 5B.

In this example, the magnet system 530 includes a first magnet 531 positioned adjacent at least part of a cavity 510 for generating a magnetic field having a field direction substantially orthogonal to the cavity 510 and a field gradient along the cavity 510. Again, the first magnet 531 is a substantially disc shaped magnet having a surface 531.1 that defines a substantially circular plane.

At least one magnetic body, is provided near the sensor 511 to modify the field in the vicinity of the sensor 511. In this example, the at least one body includes a second magnet 532 and a third magnetic body 533, which modify the magnetic field to thereby increase the field gradient and modify the field gradient direction in a region near the sensor 511. The second magnet is 532 a spherical magnet, whilst the third body is a hemispherical body 533 formed from a ferromagnetic material, which acts to concentrate the magnetic flux in the vicinity of the sensor 511.

In this example, the cavity 510 again includes a first cavity portion 510.1 extending towards a centre of the circular plane at an angle relative to the plane and a second cavity portion 510.2 extending from the first cavity portion in a direction substantially parallel to the plane and radially outwardly towards the circumference of the surface.

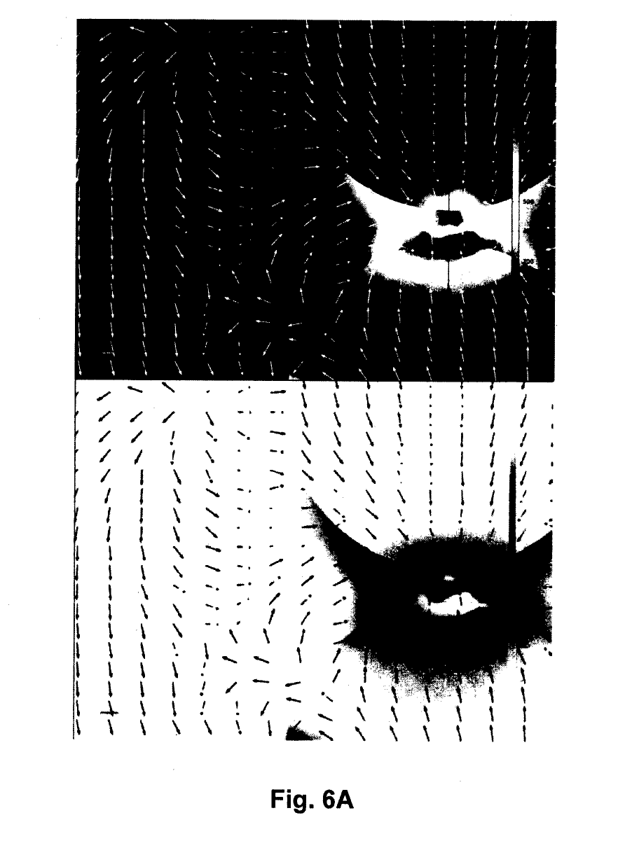

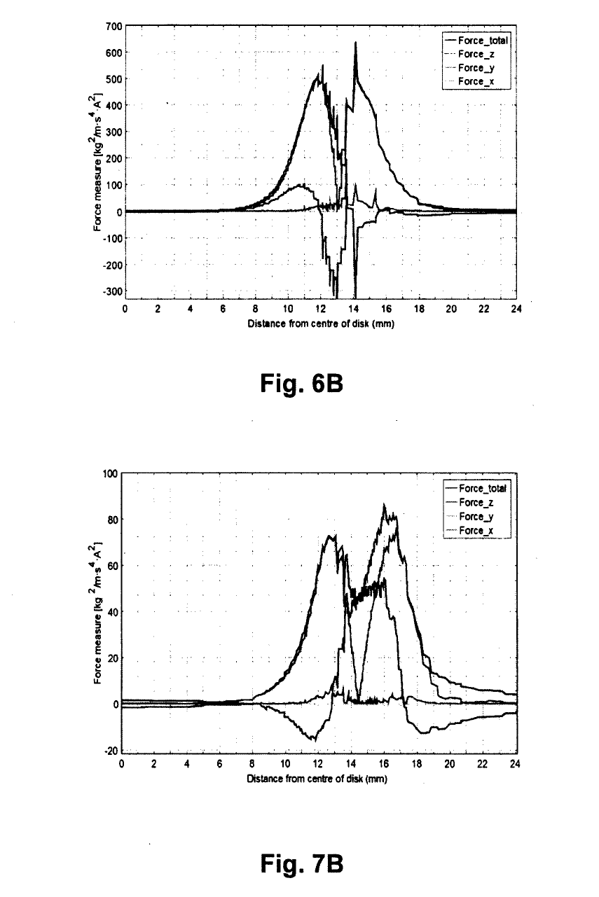

An example of the magnetic field generated by the magnet system will now be described in more detail with reference to FIGS. 6A and 6B.

In this example, the hemispherical flux concentrator 533 is made of iron and has the same radius as the spherical magnet 532. The cavity 5110, and in particular the sensor 511, is positioned between the flux concentrator 533 and the second magnet 532.

Again, the field is modelled using a COSMOL modelling software. In addition to the parameters outlined above with respect to the examples of FIG. 3A to 3G, the flux concentrator 533 is assigned the relative permeability of iron, namely μᵣ=4000.

The magnetic force in the y-z plane is shown in FIG. 6A. As shown, the generated magnetic field results in an additional force Fₘ in a negative z-direction, thereby urging the labelled analyte towards the sensor 511. Additionally, as shown by the magnetic force component plot in FIG. 6B, F_{y}>F_{z} and that as a result there is a negative z-direction force in the region of 12 to 13 mm outwardly from centre of the disc magnet 531, albeit with a greater force along the cavity 510. However, it should also be noted that there is still a region of force in the positive z-direction in the region of 9 to 12 mm from the centre of the disc magnet 531, which the labelled analyte must pass through before reaching the sensor 511. Accordingly, in another example, the spherical magnet 532 can be replaced by a cylindrical magnet.

In particular, the positive z-direction force towards the spherical magnet originates due to the fact that the surface of the spherical magnet is curved. Magnetic flux that does not pass directly through the air gap between the spherical magnet 532 and the top of the disc magnet 531 is concentrated at the sides of the spherical magnet 532. This means that there is a slight field gradient pointing towards these areas of the spherical magnet 532, creating a corresponding magnetic force in this direction.

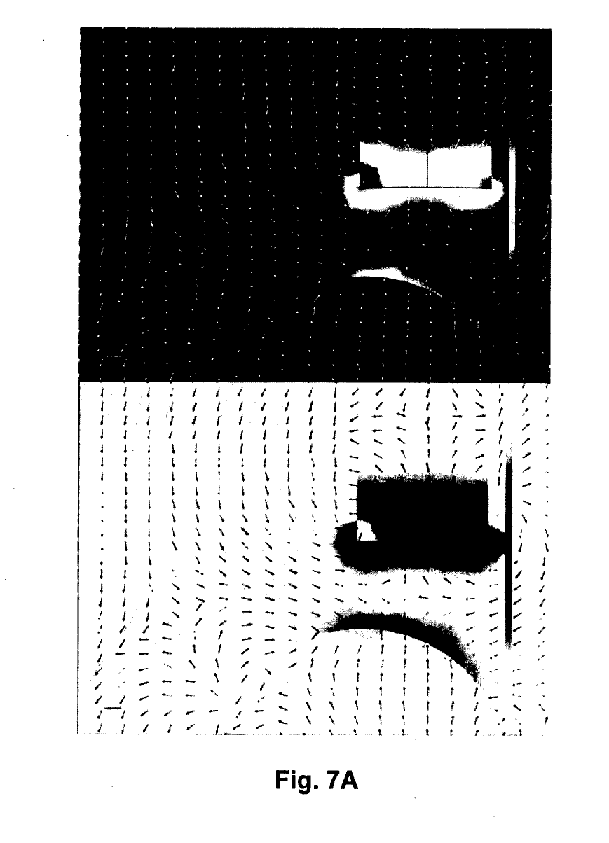

By replacing the spherical magnet 532 with a cylindrical magnet, the cylindrical magnet has flat ends which assist in further reducing the magnetic force in the positive z-direction, enhancing the force towards the sensor 511. The cylindrical magnet is modelled with the same material as the spherical magnet and has a diameter of 4.5 mm and height of 10 mm. The resulting COMSOL model magnetic force in the y-z plane is shown in FIG. 7A, with the net magnetic forces being shown in FIG. 7B.

In this example, it should be noted that the cylindrical magnet 532 has also been offset radially outwardly from the flux concentrator 533 by 1 mm, and that the distance between the cylindrical magnet 532 and the flux concentrator 533 has been increased from 1 to 3 mm. Although this decreases the maximum magnetic field and hence the force, it helps increase the force in the negative z-direction, because the magnetic flux concentrated by the circular edge of the cylindrical face of the second magnet 532 is now further above and to the side of the flux concentrator 533, thereby lessening its influence on the labelled analyte trajectories.

It is apparent from FIG. 7A that the resulting labelled analyte trajectories are well-behaved, moving in a negative z-direction towards the middle of the flux concentrator 533. As shown in FIG. 7B, there is a much larger region of the cavity 510 in which the magnetic force urges the labelled analyte in a negative direction in the region from 8 to 13 mm radially outwardly of the centre of the disc magnet 531. This provides enough ‘runway’ for the labelled analytes to be inserted into the cavity 510 allowing the labelled analytes to gain velocity in a y-direction and z-direction, towards the sensors at the bottom of the cavity 510, the bottom being closest to the first magnet 531.

Accordingly, the magnetic arrangement of a cylindrical permanent magnet 532 suspended 3 mm above and 1 mm to the side of a hemispherical flux concentrator 532 resting on a disc magnet 531 provides an optimum configuration for urging the labelled analytes towards the sensors 511.

In particular, the magnetic configuration provides a magnetic force along the cavity 510, with an additional negative z-direction force urging the labelled analytes towards the sensors 511, thereby ensuring good detection of the labelled analytes. Furthermore, this arrangement ensures that the sensor 510 is provided at a location where the velocity of the labelled analytes in the y-direction is greatest, allowing for quick and efficient analysis of the labelled analytes.

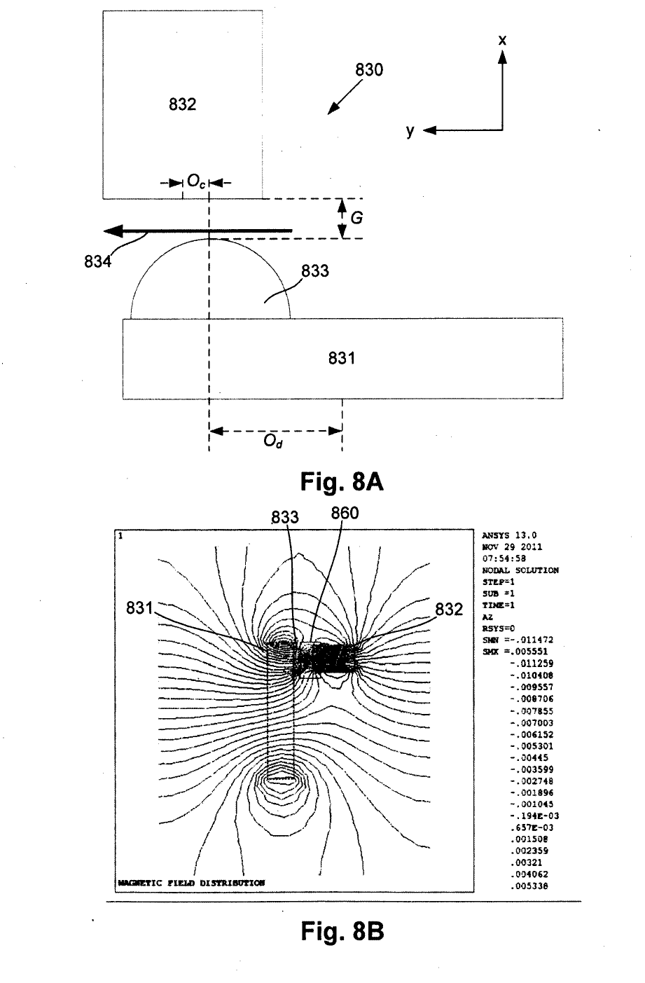

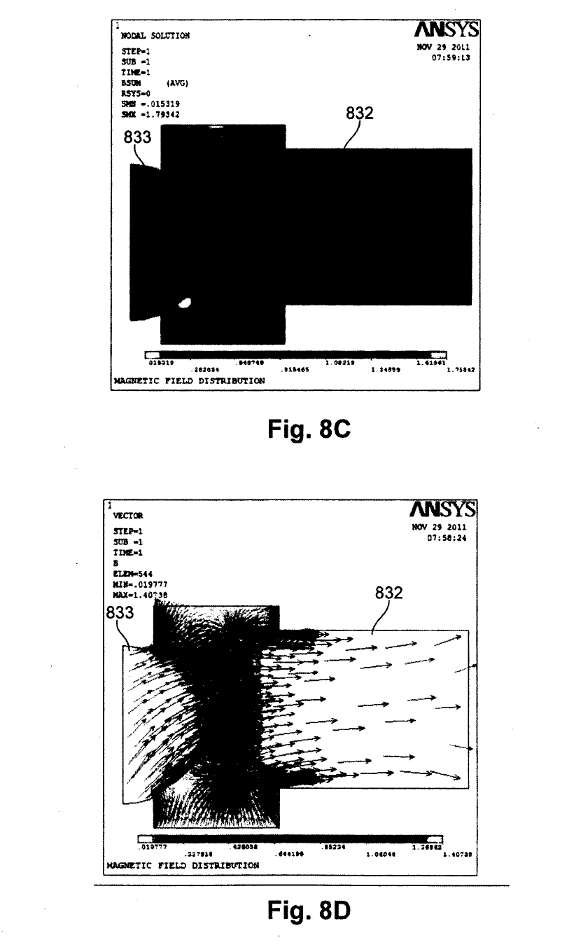

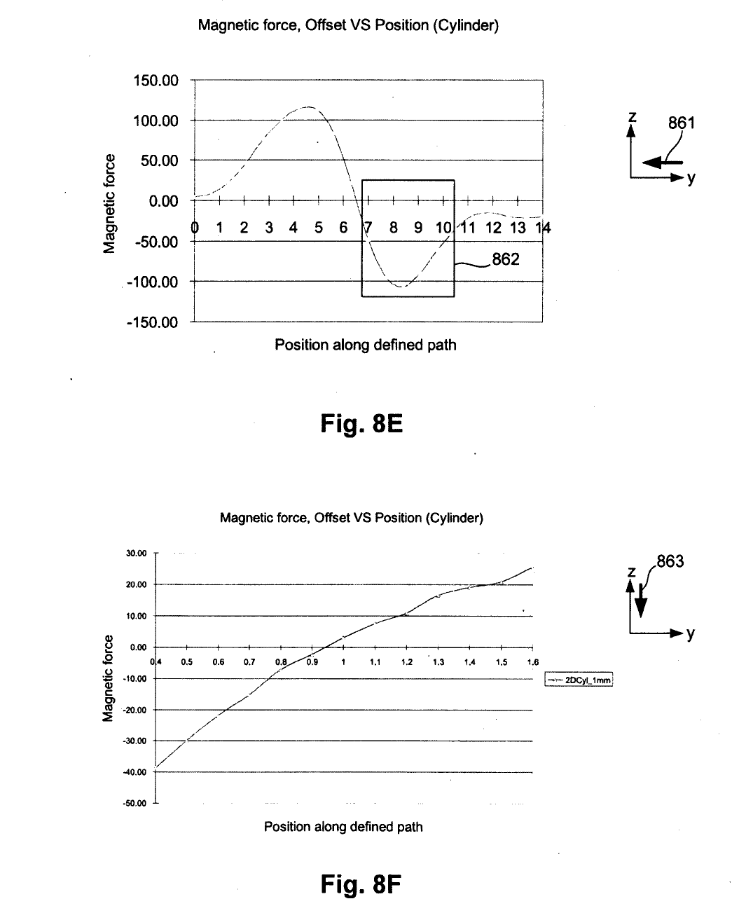

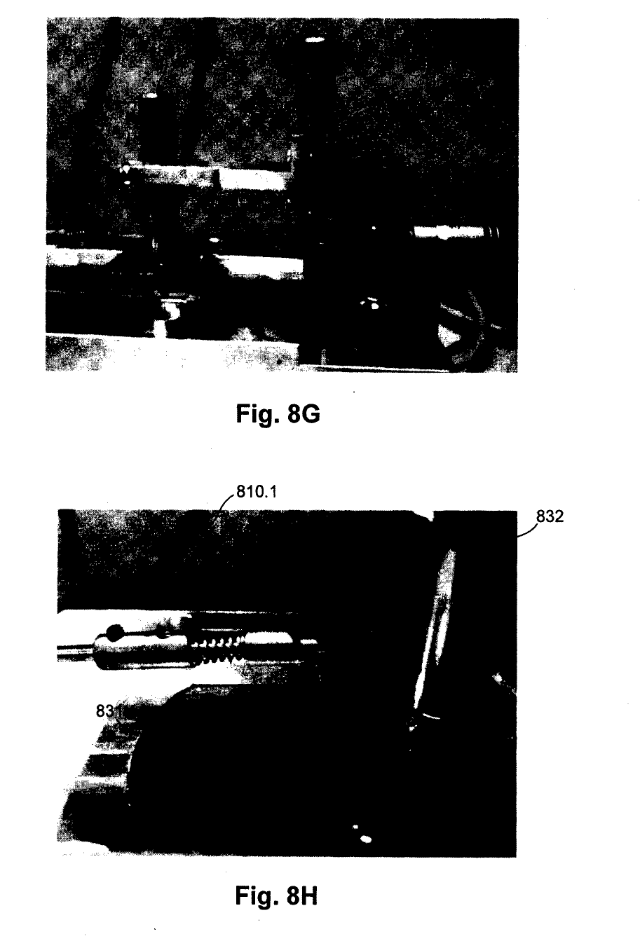

A further example of a magnet system for use in a transporting and sensing apparatus will now be described with reference to FIG. 8A.

In this example, the magnet system 830 includes a first substantially disc-shaped magnet 831, a second substantially cylindrical magnet 832 and a third substantially hemispherical magnetic body 833. It will be appreciated that the arrangement of the magnet system is therefore generally similar to that described above with respect to the example of FIG. 7A and 7B.

In this instance the third magnetic body 833 is offset from the centre of the first magnet 831 by a distance O_{d}=18 mm, whilst the second magnet 831 is offset from the centre of the third magnetic body 833 by a distance O_{c}=1 mm. The gap between the second magnet and the third magnetic body 833 G=2 mm. In use the analyte is transported along a defined path shown by the arrow 834, with the defined path being offset from the third magnetic body 833 by 0.5 mm.

It will therefore be appreciated that the magnet system is similar to those described above, with specific relative positioning of the first and second magnets 831, 832 and the third magnetic body 833.

The magnetic field generated by the magnet system 830 was modelled with ANSYS, an electromagnetic modelling software package.

The resulting magnetic field distribution modelled with ANSYS software is shown in FIGS. 8B to 8D, with FIGS. 8C and 8D showing details of the region 860 shown in FIG. 8B.

FIG. 8E shows the magnetic force profile derived from the ANSYS model, along the y axis (with the direction of travel of the analyte being shown by the arrow 861). In this example, the y axis starts from the edge of the first magnet 831, with the desired force having a negative sign, because it runs against the axis direction. The highlighted rectangle 862 shows a 3.5 mm region where the force is in desirable range and directionality, suitable for magnetic analyte transport.

FIG. 8F shows the magnetic force profile derived from the ANSYS model, along the z axis (downward force shown by the arrow 863). In this example, the z axis starts from the top of the third magnetic body 833. The desired force has a negative sign, because it runs against the axis direction. As can be seen, at 0.5 mm from the top of the hemispheric flux concentrator there is significant downward force, so the positioning of a sensor, such as a sensor chip 811 (shown in FIGS. 8G and 8H), in that plane would result in analytes being magnetically forced down towards the sensor.

As shown in FIGS. 8G and 8H the magnetic system 830 was constructed and integrated with a sensor chip 811 and a pathway 810.1 allowing analytes to be transported utilising the techniques described above.

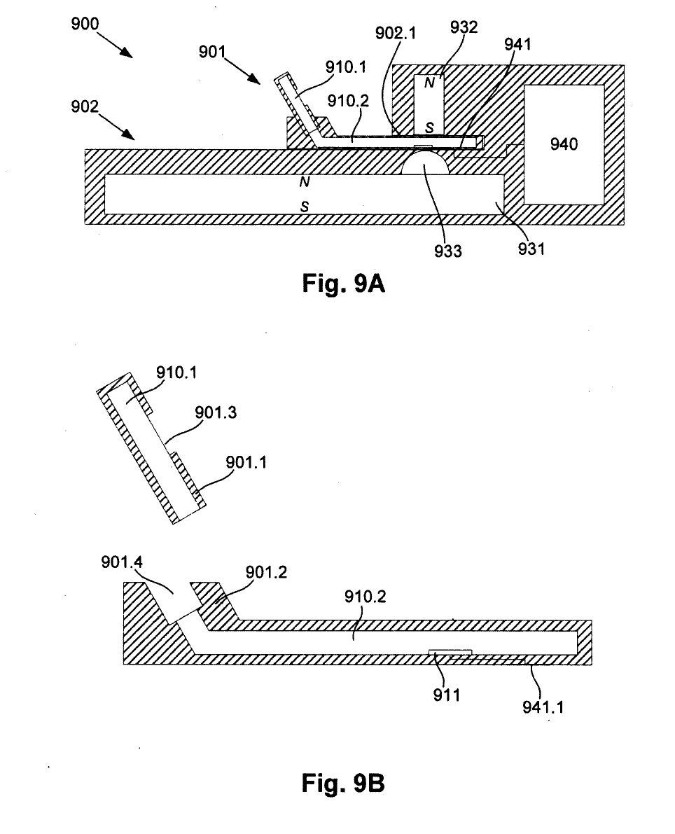

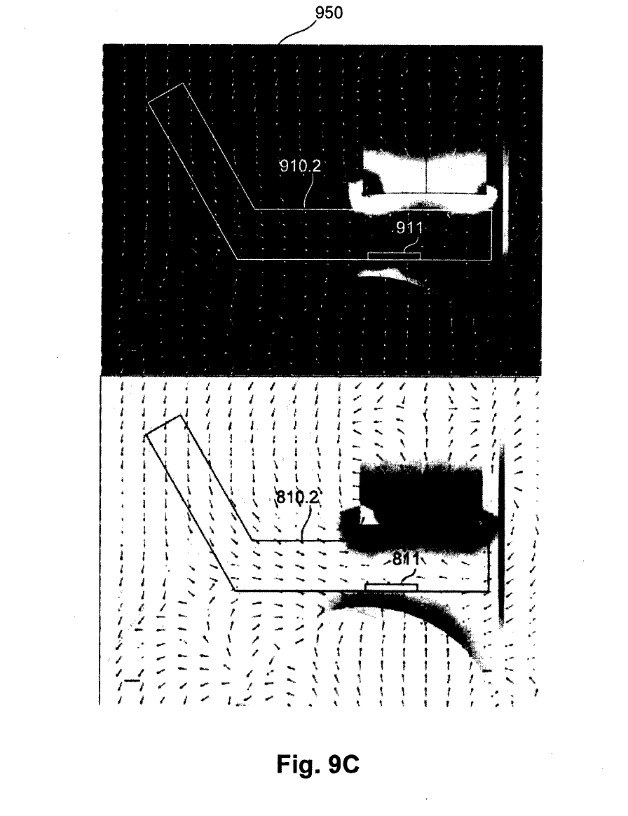

A further specific example apparatus will now be described with reference to FIGS. 9A and 9B.

In this example, the apparatus 900 includes a first housing 901 containing the cavity and a second housing 902 containing the magnet system. In this example, the second housing includes a recess 902.1 for receiving the first housing 901 to thereby position the cavity 910 relative to the magnet system 930.

In one example, the second housing 902 also includes a processing electronics 940 for detecting signals from the sensor 911. Typically this is achieved by having a connector 941, including a first connector 941.1 in the first housing 901, which connects to a corresponding connector in the second housing 902, thereby electrically connecting the sensor 911 to the processing electronics 940. The processing electronics may be any form of processing electronics, which in one example is capable of detecting the electrical signal generated at the sensor 911.

In one example, the processing electronics 940 could include a display for providing an indication of the signal, although alternatively the processing electronics could be adapted to electronically transfer an indication of the signal to a remote computer system, for example using a wireless connection, thereby allowing the computer system to interpret the signal and provide indications indicative of the analytes detected.

In one particular example, the first housing 901 includes a first housing portion 901.1 containing a first cavity portion 910.1 and a second housing portion 901.2 containing a second cavity portion 910.2. This allows a sample including the labelled analytes to be easily provided into the first cavity portion 910.1, for example via an aperture 901.3. The second housing includes a recess 901.4 for receiving the first housing portion 901.2, thereby coupling the first housing 901 to the second housing 902. This in turn connects the first cavity portion 910.1 to the second cavity portion 910.2, allowing labelled analytes to be urged through the cavity 910 to the sensor 911.

This arrangement allows the cavity portion 910.1 to be populated with a sample including one or more labelled analytes. The cavity portion 910.1 is then coupled to the second cavity portion 910.2, and then the first and second housings are connected, by inserting the first housing 901 into the recess 902.1 of the second housing. The magnetic field generated by the magnet system, and in particular the first and second magnets 931, 932 and the flux concentrator 933 urge the labelled analytes along the cavity towards the sensor, as shown by the force lines 950.

As shown in FIG. 9C, when this particular arrangement is used, the combination of a cylindrical second magnet 932, hemispherical flux concentrator 933 and first magnet 931 advantageously generate a field gradient aligned with both the first and second cavity portions 910.1, 910.2, so that labelled analytes are urged from the first cavity portion 910.1, into the second cavity portion 910.2 and hence towards the sensor 911, as shown. This therefore allows for accurate and rapid sensing of labelled analytes 920 added into the first cavity portion 910.1. It should be noted that similar field properties are also demonstrated with the arrangements of FIGS. 2A and 5A, so that field will urge labelled analytes along the first cavity portions 210.1, 510.1 in a similar manner.

It will be appreciated that the above described arrangement allows multiple first housings 901 to be used in conjunction with a common second housing 902, so that multiple cavity 910, and hence multiple analytes can be used detected using a common magnet and sensing system.

Accordingly, it will be appreciated that the above described transport arrangement provided by the magnet arrangement allows labelled analytes including an analyte to be transported to a sensor for subsequent sensing for a suitable sensor.

In the above examples, whilst the magnets are made from neodymium rare earth magnets (grade N48) and the flux concentrator is iron, due to its high magnetic permeability, it will be appreciated that alternative configurations, could be used. For example, the magnet system could include a number of electromagnets arranged to provide a similar field configuration. However, the use of permanent magnets is beneficial as this avoids the need for power to be used to generate the magnetic field, whilst ensuring a consistent and stable field without the need for complex control mechanisms. This ensures that the analyte transport mechanism is cheap and easy to manufacture.

As used herein, the term “cavity” could include any channel, chamber, or the like capable of containing a fluid.

As used herein, the term “analyte” refers to naturally occurring and/or synthetic substance, including chemical and/or biological molecules that can be measured in an analytical procedure. Example analytes can include, but are not limited to epigenetic markers, RNA, DNA, nucleic acids or proteins, antigens, antibodies, allergens, or adjuvants, parasites, bacteria, viruses, or virus-like particles, immunoglobulins, chemokines or cytokines, to hormones, epigenetic markers, such as the methylation state of DNA, or chromatin modifications of specific genes/regions, or the like.

As used herein, the term “labelled analyte” includes any complex including an analyte bound to at least a magnetic particle, and optionally other particles.

Persons skilled in the art will appreciate that numerous variations and modifications will become apparent. All such variations and modifications which become apparent to persons skilled in the art should be considered to fall within the spirit and scope of the invention broadly appearing and described in more detail herein.

It is to be appreciated that reference to “one example” or “an example” of the invention is not made in an exclusive sense. Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise.

Features that are common to the art are not explained in any detail as they are deemed to be easily understood by the skilled person. Similarly, throughout this specification, the term “comprising” and its grammatical equivalents shall be taken to have an inclusive meaning, unless the context of use clearly indicates otherwise.

1. An apparatus for sensing an analyte, the analyte being bound to at least one magnetic particle to form a labelled analyte, and wherein the apparatus includes:
a cavity having a sensor therein, wherein in use the cavity contains a fluid and at least one labelled analyte; and,
a magnet system for generating a magnetic field having a field direction substantially orthogonal to at least part of the cavity to orientate the at least one labelled analyte in the cavity and a field gradient along at least part of the cavity to thereby urge the at least one labelled analyte along the cavity towards the sensor.

2. An apparatus according to claim 1, wherein the sensor is provided on a wall of the cavity, and wherein the field gradient extends in a field gradient direction, the field gradient direction being at an angle relative to the cavity at least near the sensor to thereby urge the at least one labelled analyte towards the sensor.

3. (canceled)

4. An apparatus according to claim 2, wherein the field gradient includes a component along the cavity and a component orthogonal to the cavity to thereby urge the labelled analyte along the cavity and towards the sensor.

5. An apparatus according to claim 1, wherein the magnet system includes:
a first magnet positioned adjacent at least part of the cavity for generating a magnetic field having a field direction substantially orthogonal to the cavity and a field gradient along the cavity; and,
at least one body for modifying the magnetic field near the sensor to thereby at least one of
increase the field gradient; and,
modify a field gradient direction.

6. An apparatus according to claim 5, wherein the at least one body includes at least one of:
a second magnet; and,
a third magnetic body.

7. An apparatus according to claim 6, wherein the sensor is positioned at least one of:
substantially between the first and second magnets; and
substantially between the second magnet and the third body.

8. (canceled)

9. An apparatus according to claim 6, wherein the third body is positioned between the first magnet and the cavity, and the cavity is positioned between the second magnet and the third body.

10. An apparatus according to claim 5, wherein the first magnet defines a substantially circular plane, at least part of the cavity extending in a direction substantially parallel to the plane and radially outwardly towards a circumference of the first magnet.

11. An apparatus according to claim 10, wherein the cavity includes:
a first cavity portion extending towards a centre of the circular plane at an angle relative to the plane; and,
a second cavity portion extending from the first cavity portion in a direction substantially parallel to the plane and radially outwardly towards the circumference of the region.

12. An apparatus according to claim 10, wherein the at least one body is positioned adjacent the cavity radially outwardly from a centre of the first magnet.

13. An apparatus according to claim 5, wherein the first magnet is at least one of a rare earth magnet, an electromagnet, and a disc magnet.

14. (canceled)

15. An apparatus according to claim 5, wherein the second magnet is at least one of a rare earth magnet, an electromagnet, and at least one of a cylindrical and a spherical magnet.

16. (canceled)

17. An apparatus according to claim 5, wherein the third body is a ferromagnetic material.

18. An apparatus according to claim 5, wherein the third body is hemispherical body coupled to the first magnet.

19. An apparatus according to claim 1, wherein the apparatus includes:
a first housing containing the cavity; and,
a second housing containing the magnet system, and wherein the second housing includes a recess for receiving the first housing to thereby position the cavity relative to the magnet system.

20. An apparatus according to claim 1, wherein the first housing includes:
a first housing portion containing a first cavity portion; and,
a second housing portion containing a second cavity portion.

21. An apparatus according to claim 1, wherein the sensor includes electrodes for determining a diffusion-limited electrochemical current.

22. An apparatus for transporting an analyte to a sensor to allow sensing of the analyte, the analyte being bound to at least one magnetic particle to form a labelled analyte, and wherein the sensor is mounted in a cavity containing a fluid and at least one labelled analyte, and wherein the apparatus includes a magnet system for generating a magnetic field having a field direction substantially orthogonal to at least part of the cavity to orientate the at least one labelled analyte in the cavity and a field gradient along at least part of the cavity to thereby urge the at least one labelled analyte along the cavity towards the sensor.

23. An apparatus according to claim 22, wherein a first housing contains the cavity and wherein the apparatus includes a second housing containing the magnet system, the second housing including a recess for receiving the first housing to thereby position the cavity relative to the magnet system.
